(19) United States
(12) Patent Application Publication
(10) Pub. No.: US 2017/0305591 A1
(43) Pub. Date: Oct. 26, 2017

(54) WIDE-NECKED CONTAINER HAVING AN ATTACHED THREADED SLEEVE

(71) Applicant: SIDEL PARTICIPATIONS, Octeville-Sur-Mer (FR)

(72) Inventor: Mikael DERRIEN, Octeville-sur-mer (FR)

(21) Appl. No.: 15/537,196

(22) PCT Filed: Dec. 10, 2015
(86) PCT No.: PCT/FR2015/053413

§ 371 Date: Jun. 16, 2017

(30) Foreign Application Priority Data
Dec. 17, 2014 (FR) 1462669

(51) Int. Cl. B65D 1/02; B29C 49/12; B29C 49/22; B29C 49/42; B65D 85/72; B29C 49/06; B29L 31/00; B29K 67/00

(52) U.S. Cl. CPC B65D 1/0246; B65D 85/72; B29C 49/12; B29C 49/06; B29C 49/22; B29C 49/4278; B29B 2911/14053; B29B 2911/1414; B29B 2911/1424; B29B 2911/1444; B29K 2067/003; B29L 2031/716

(57) ABSTRACT

A method for producing a container having a threaded wide neck, includes steps of: heating a preform having a polyester body, on which there is mounted a polyolefin sleeve positioned next to an area of the body corresponding to the wide neck of the container; introducing the heated preform, with the sleeve, into a mould having the footprint of the container, including a threaded area having the footprint of the wide neck; injecting a pressurised fluid into the preform in order to form a blank of the container including a lower portion including the wide neck with a thread formed in the sleeve and an upper portion above the wide neck; separating the upper portion from the lower portion that thus forms the container.

The invention relates to the manufacture of containers of plastic material and more specifically containers having a threaded wide neck (a neck whose diameter is greater than or equal to half of the overall diameter of the container is considered to be wide).

Wide-necked containers, currently referred to by the name “jars,” are generally intended for particular applications, particularly for contents filled in the form of paste (of the ketchup, mustard, purée, compote type) whose viscosity is such that these contents cannot be dispensed both at a high flow rate and with a small flow cross-section. The jars, however, can still accommodate liquids, typically non-alcoholic drinks (fruit juices, fruit drinks, tea, energy drinks), or solids (such as powders).

The forming of such a jar by blow molding is normally performed by blow molding or stretch blow molding from a preform made of plastic material provided with a cylindrical body and inserted hot into a mold provided with a wall having the impression of the container. The wall includes a threaded area that corresponds to the neck, which will be formed in the area of the body of the preform. A fluid (generally air) under pressure is injected into the preform to flatten the material (rendered soft by prior heating) against the wall so as to form a blank of the container, comprising a lower part having a body and the neck, and an upper part topping the neck. After the blank leaves the mold, the upper part is separated from the lower part. The lower part is preserved (it forms the final container), while the upper part is discarded, for the purpose of, for example, being recycled as raw material for the manufacture of new preforms. The U.S. patent U.S. Pat. No. 6,841,117 (Graham Packaging) illustrates this technique.

To make a jar having good properties of transparency, the material used is in general a polyester, particularly PET (polyethylene terephthalate). PET offers the advantage of imparting to the final container good mechanical properties, but it has the drawback of necessitating, for a good impression-taking of the threads of the neck, a high blow-molding pressure (greater than or equal to about 35 bars). The blow-molding pressure is higher the thicker the material is in the area of the neck. To increase the thickness of material to attempt to improve the impression-taking therefore results only in proportionally increasing the blow-molding pressure, without thereby obtaining a satisfactory impression-taking. In contrast, reducing the thickness of material in the area of the neck causes a reduction in the mechanical strength, at the expense of the ease of closing and of final sealing of the container. Furthermore, despite a reduced thickness, the impression-taking in the area of the threads remains mediocre.

A first objective is to propose a technique making it possible to manufacture a wide-necked container that can be formed at reduced blow-molding pressures.

A second objective is to propose a technique making it possible to facilitate the impression-taking of the threads in the area of the neck, so as to guarantee the easy and tight screwing of a lid, as well as the unscrewing of it without difficulty.

For this purpose, in the first place, a method is proposed for manufacturing a container made of plastic material having a threaded wide neck, which comprises the operations consisting in:
heating a preform having a body formed from a polyester, on which a sleeve formed from a polyolefin is mounted, this sleeve being positioned in line with an area of the body of the preform corresponding to the wide neck of the container;
inserting the preform thus heated, with the sleeve, into a mold provided with a wall defining an impression of the container and including a threaded area having the impression of the wide neck;
injecting into the preform a pressurized fluid to form a blank of the container by taking an impression against the wall of the mold, this blank comprising a lower part that includes the wide neck with a threading formed in the sleeve and an upper part topping the wide neck;
separating the upper part of the blank from its lower part that thus forms the container.

The polyolefin sleeve has the advantage of an impression-taking that is better than the polyester. The threads are better formed, enhancing the ease—and the quality—of the closing.

Various additional characteristics can be provided, alone or in combination:
the separation operation is performed by cutting;
the cutting is performed along a line adjacent to the sleeve;
the body of the preform is made of PET;
the sleeve is made of HDPE;
the sleeve has, in cross-section, a thickness of between 0.5 mm and 2.5 mm, and, for example, less than or equal to 1.5 mm;
the fluid is injected into the preform at a pressure that is less than 10 bars;
the fluid is air.

In the second place, a container made of plastic material is proposed, said container comprising a side wall formed from a polyester (such as PET), and a wide neck provided with a threading, the threading of the neck being performed in a sleeve formed from a polyolefin (such as HDPE) that covers an upper end portion of the wall. According to a particular embodiment, the upper end portion of the side wall can have an attenuated impression of the threading, so as to ensure a better hold of the sleeve on the side wall during opening and closing of the container.

Other objects and advantages of the invention will be brought out in the description of an embodiment, made below with reference to the accompanying drawings in which:

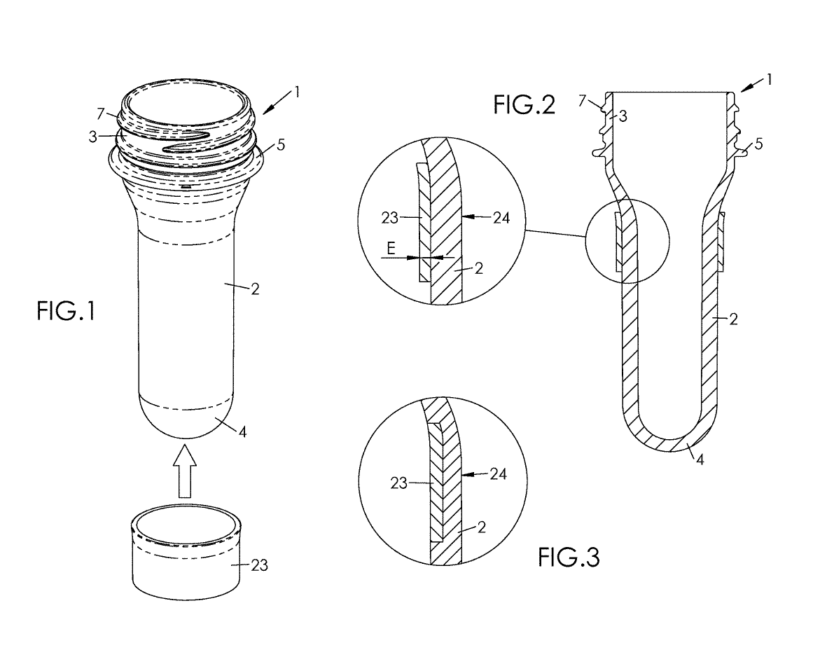

FIG. 1 is a view in perspective showing a preform and an added sleeve intended to be threaded on the preform;

FIG. 2 is a cutaway view of the preform and of the sleeve after it is mounted; the detail inset shows the positioning of the sleeve on an enlarged scale;

FIG. 3 is a view similar to the detail inset of FIG. 2, illustrating a variant embodiment;

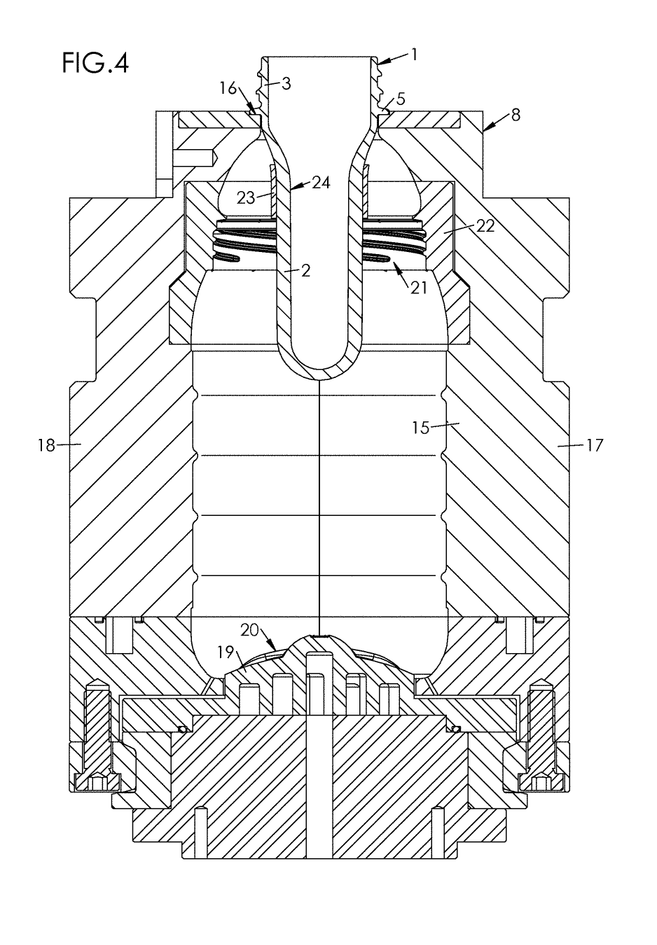

FIG. 4 is a cutaway view showing the preform of FIG. 2 mounted in a mold for the forming of a container blank whose mold defines the impression;

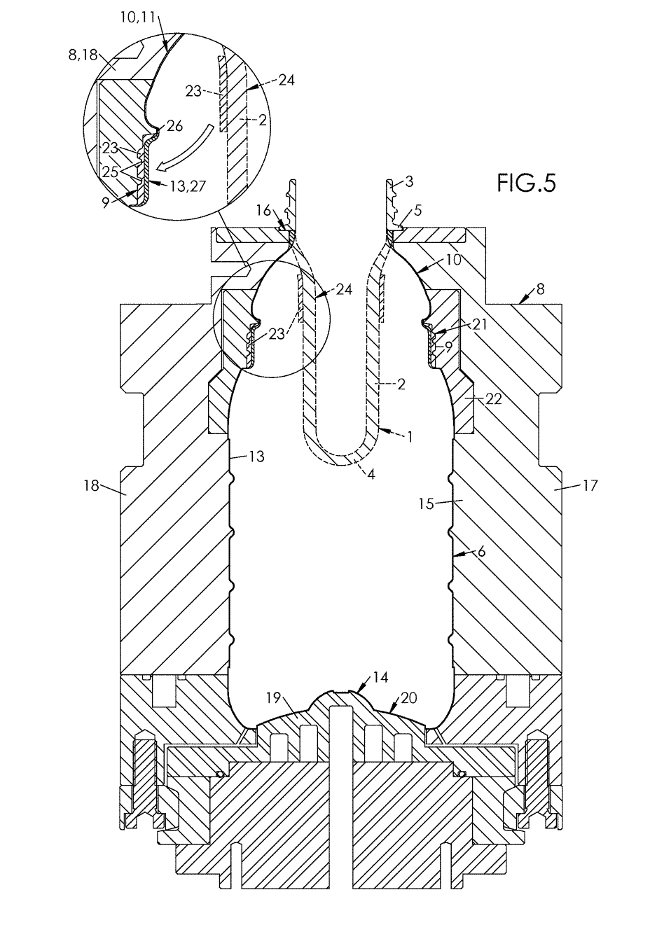

FIG. 5 is a cross-section illustrating the forming of the blank in the mold starting from the preform (shown in broken lines);

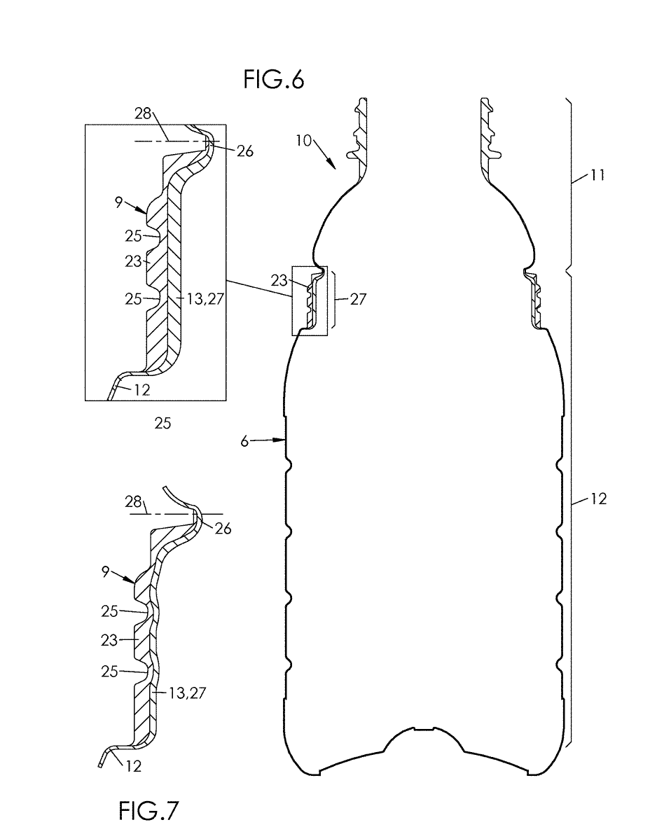

FIG. 6 is a cross-section showing the container blank that is formed and outside of the mold; the detail inset shows the structure of the threaded neck formed on the body of the blank on an enlarged scale;

FIG. 7 is a view similar to the detail inset of FIG. 6, illustrating a variant embodiment;

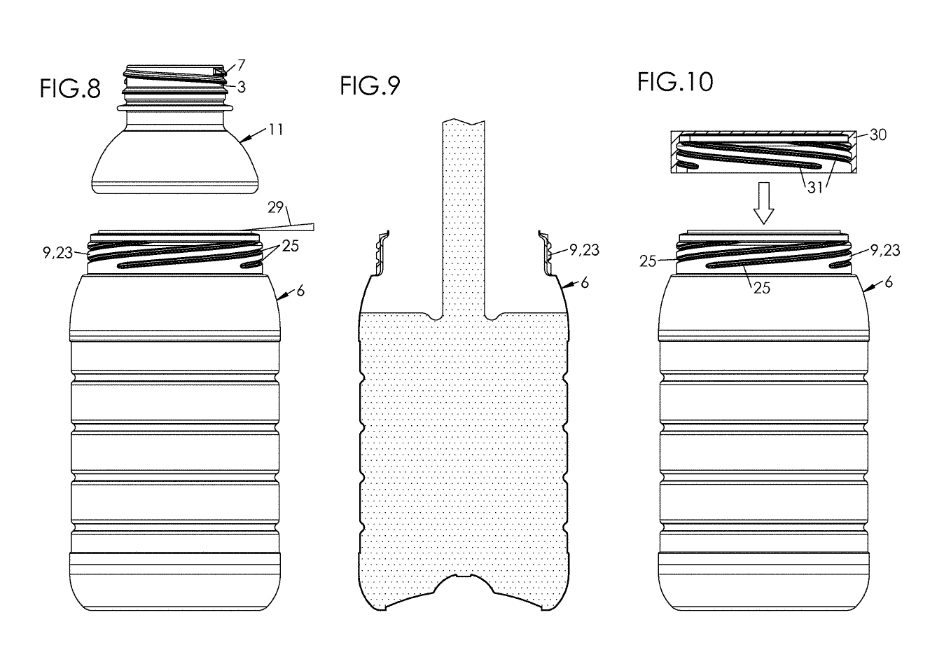

FIG. 8 is a front view of the container, formed from the blank of FIG. 7, from which the upper part has been cut;

FIG. 9 is a cross-section illustrating the filling of the container;

FIG. 10 is a partial-cutaway front view illustrating the closing of the container.

In FIG. 1, a preform 1 made from a polyester is illustrated. According to a preferred embodiment, the polyester is of the PET (polyethylene terephthalate) type. It will be noted that the name “polyethylene terephthalate” is a misnomer since PET, obtained by polycondensation of ethylene glycol with terephthalic acid, is not a polyethylene.

PET is a semi-crystalline polymer having good properties for forming by blow molding or stretch blow molding, this process imparting to it a good mechanical strength linked to its dual molecular orientation (both axial and radial) and to its relatively high rate of crystallinity (generally greater than 20%).

Nevertheless, the production of certain forms that do not cause problems for other materials (particularly polypropylene, frequently used for the manufacture of containers accommodating household products—detergents, cleaners, caustic substances) is difficult during blow molding of polyesters and particularly of PET. Such is the case of the threads to be formed over an area intended to form a wide neck on which a lid will be screwed.

As is seen in FIG. 1, the preform 1, raw from injection, has a body 2, of overall cylindrical shape, a neck 3 (formed during the injection) that extends from an upper end of the body 2, and a hemispherical bottom 4 that extends to a lower end of the body 2 and closes the preform 1. The neck 3 is separated from the body 2 by a collar 5 that has the function of facilitating the gripping of the preform 1 during the various steps for manufacture of a container 6 from it.

The fact that the neck 3 comprises a thread 7 illustrates the fact that this preform 1 can be a standard preform currently used to form an ordinary container (such as a bottle) whose neck, used for filling, closing and emptying, is the one (unchanged during the manufacture of such an ordinary container) of the preform.

In the present case, if the collar 5 is used as usual to ensure the gripping of the preform 1 and particularly to suspend the preform 1 in a mold 8, as will be explained below, the neck 3 is not, however, intended to remain on the final container 6.

Actually, the final container 6, illustrated in FIGS. 9 and 10, comprises a wide threaded neck 9, formed in the area of the body 2 of the preform and separate from its neck 3. The container 6 is not directly obtained by forming of the preform 1 in the mold 8. Actually, this forming results in a blank 10, illustrated in FIGS. 5 and 6.

This blank 10 comprises a lower part, corresponding to the final container 6 and including the wide neck 9, and an upper part 11 topping the wide neck 9. This upper part 11, which includes the initial neck 3 coming from the preform 1, is intended to be separated from the lower part (i.e., of the final container 6) by a cutting operation, as will be described below. The lower part (i.e., of the final container 6) comprises a body 12 with an overall cylindrical shape, defined by a side wall 13 made of polyester (obtained from the body 2 of the preform 1) and closed opposite the wide neck 9 by a bottom 14.

The mold 8 intended for the forming of the blank 10 is illustrated in FIGS. 2 and 3. This mold 8 comprises a side wall 15 that defines, from an open upper end whose periphery forms a bearing area 16 for the collar 5, an impression of the blank 10 (and therefore, secondarily, of the container 6 to be formed).

According to a particular embodiment, the mold 8 is of the wallet type and comprises two half-molds 17, 18, which are mobile in relation to one another (typically in rotation), and a mold bottom 19 whose upper face 20 defines an impression for the bottom 14 of the container 6.

As can be seen clearly in FIGS. 4 and 5, the mold 8 includes, in its wall 15, a threaded area 21 having the impression of the wide neck 9 of the container 6. In the example illustrated, the threaded area 21 is formed in an added insert 22, which facilitates the change in reference—i.e., in the model of the container to be manufactured, when the shape and/or the diameter of the wide neck 9 is/are different.

Since the forming of the wide neck 9 in the polyester body 2 of the preform 1 does not make possible a good impression-taking of the threaded area 21, a sleeve 23 formed from a polyolefin is mounted on the body 2 of the preform 1 in line with an area 24 of the body 2 corresponding to the wide neck 9 of the container 6 to be formed. The polyolefin can be a polyethylene, in particular an HDPE (high-density polyethylene), advantageous for its forming capabilities, its food compatibility, and its ease of recycling.

According to a first embodiment illustrated in FIGS. 1 and 2, the sleeve 23 is manufactured separately from the preform 1, then added to it by being threaded on the body 2 (from the bottom 4, as suggested by the arrow in FIG. 1) to a predetermined height. The sleeve 23 thus forms a thickening on the body 2 of the preform 1.

The inner diameter of the sleeve 23 is approximately equal to (while being optionally slightly less than) the outer diameter of the body 2, so that the mounting of the sleeve 23 is relatively tight, so as to prevent its movement or its inadvertent separation from the preform 1.

According to a second embodiment, the preform 1 and the sleeve 23 are manufactured concurrently by co-molding (i.e., by co-injection). In this case, illustrated in FIG. 3, the sleeve 23 can be incorporated into the body 2 of the preform 1 so as not to form a thickening on it.

The thickness (measured radially and denoted E in FIG. 2) of the the sleeve 23 in cross-section is preferably between 0.5 mm and about 2.5 mm. According to a preferred embodiment, the thickness E of the sleeve 23 is about 1.5 mm.

Determining with precision the axial positioning (i.e., parallel to the general direction of extension of the preform 1) of the sleeve 23 on the body 2 of the preform 1 can be achieved by successive forming tests until the sleeve 23 is correctly positioned on the final container 6. As a variant, this position can be calculated as a result of the models (generally empirically derived) for distribution of the material as a function of the rates of orientation of it during the forming, as well as of the stretching speeds used.

Tests have shown that, unlike the preform 1, the sleeve 23 does not undergo (or undergoes little) axial lengthening during the stretching of the preform 1, during the forming of the blank 10. It is understood therefore that the sleeve 23 must have from the start a height that is greater than or equal to that of the threaded area 21. The axial stretching of the body 2 of the preform 1 is relatively uniform, even in the area of the sleeve 23, because of its slight adhesion to the body 2. This slight adhesion is linked to the paraffinic nature of the polyolefin, as a result of which the sleeve 23 has, at the interface with the body 2 of the preform 1, a low coefficient of friction that makes possible a sliding of the preform 1, during its axial stretching, relative to the sleeve 23. The sleeve 23, however, undergoes a radial stretching as the blow molding of the preform 1 progresses.

As suggested by the arrow in the detail inset of FIG. 5, the stretching of the part of the preform 1 located between the sleeve 23 and the collar 5 moves the sleeve 23 axially in the mold 8, during the forming, to bring it in line with the threaded area 21 of the mold 8.

The continuing forming causes the embedding of the sleeve 23 in the threaded area 21 that thus impresses a threading 25 on it. The polyolefin, whose hardness is less than that of the polyester, makes possible a good impression-taking of the threading 25 in the sleeve 23.

To manufacture the container 6 from the preform 1 and from the sleeve 23, the procedure is as follows.

Firstly, the unit comprising the preform 1 and the sleeve is formed. According to a first embodiment, the preform 1 and the sleeve 23 are manufactured separately, and the sleeve 23 is then mounted on the preform 1, as indicated previously. The mounting of the sleeve 23 can be automated. It can be performed directly upon leaving the injection press of the preform 1, or later, for example immediately before the operations intended to form the container 6. According to a second embodiment, the preform 1 and the sleeve 23 are formed concurrently, for example by co-molding. In this case, the sleeve can be formed in a complementary hollow stock, formed in the body 2 of the preform 1 so that the sleeve 23 is flush with the body 2, which facilitates the handling of the preform 1 fitted with the sleeve 23 and prevents an unwanted possible sliding of the sleeve 23 before its insertion into the mold 8.

Secondly, the unit comprising the preform 1 and the sleeve 23 is heated (for example in a stream) in a heating unit. It will be noted that, in the case where the preform 1 and the sleeve 23 are manufactured separately, they can be assembled immediately before being heated. This makes it possible to store them separately. Since the preforms are stored in bulk upstream from the heating unit, it is best, actually, that they are free of sleeves because, by reason of their lower hardness, the polyolefins are more sensitive to scratching and marking than the polyesters (and in particular than PET). Further, the presence of the sleeve 23 forming a thickening on the preform 1 is likely to complicate the feeding of the preforms upstream from the heating unit.

Thirdly, the preform 1 thus heated, with the sleeve 23, is inserted into the mold 8, as illustrated in FIG. 2. It is advantageous to heat the region of the sleeve 23 to a temperature that is greater than the average temperature for heating of the preform 1, so as to further promote the impression-taking of the threading 25.

Fourthly, a pressurized fluid (such as air) is injected into the preform 1 to form the blank 10 by the taking of an impression against the wall 15 of the mold 8. Simultaneously, a stretching of the preform 1 can be initiated by means of a rod that pushes the bottom 4 of the preform 1 back until reaching the mold bottom 19. The preform 1 is drawn axially and radially at the same time. During the deformation of the preform 1, the sleeve 23, which is not (or little) stretched axially because of its slight adhesion to the body 2 of the preform 1, is brought approximately in line with the threaded area 21 of the mold 8 to be applied there and thus to take the impression of the wide neck 9 of the container 6.

Considering the ease of forming of the sleeve 23, the injection pressure is not necessarily high. Thus, it is possible without difficulty to form the container 6 illustrated in the figures with an injection pressure of less than 15 bars, and, for example, about 10 bars (the injection fluid being air). It is seen that this pressure is relatively low, compared to the usual pressures (on the order of 30 bars). Substantial savings of energy result from this.

Once the taking of the impression of the blank 10 is performed, it is ejected from the mold 8 and the cycle is repeated with a new preform 1 (also provided with a sleeve 23).

The blank 10 thus formed comprises the lower part (i.e., the container 6) and the upper part 11, integral with a junction area 26 that tops the wide neck 9 formed in the sleeve 23. The sleeve 23 surrounds the side wall 13 in an upper end portion 27 of it, contiguous with the junction area 26.

As is seen in FIG. 6, the upper end portion 27 of the side wall 13 can be internally smooth. That happens when the sleeve 23 is thick enough so that the impression of the threading 25 does not pass through it. For this purpose, the thickness of the sleeve 23 as it exists before the forming must preferably be greater than 2 mm (and, for example, about 2.5 mm). A good impression-taking of the threading 25 results. In this case, to ensure a good hold of the sleeve 23 on the side wall 13 and, in particular, to prevent the rotating of the sleeve 23 on the side wall 13 during the opening and closing, it is possible to provide lugs (or pins) that project toward the interior (or toward the exterior) of the container 6 and that, like rivets, ensure a solidarity in rotation of the sleeve 23 and the side wall 13.

If the sleeve 23 is relatively thin, the impression of the threading 25 can pass through it and the upper end portion 27 of the side wall 13 can have an attenuated impression of the threading 25, as illustrated in FIG. 7. The result is, during the closing, a reduction of the risk of slippage of the sleeve 23 relative to the upper end portion 27 of the wall 13. For this purpose, the thickness of the sleeve 23 as it exists before forming is preferably less than or equal to 1.5 mm.

Fifthly, the upper wall 11 is separated from the lower part that thus forms the container 6. This separation can be performed by detaching, which assumes a previous operation (which can be provided in the mold 8, by means of mobile inserts) of pre-cutting.

More simply, however, this separation is advantageously performed by cutting. More specifically, the blank 10 is cut in the junction area 26—along a cutting line 28 that is adjacent to the wide neck 9, therefore to the sleeve 23—to separate its upper part 11 from its lower part, which thus forms the container 6. As illustrated in FIG. 8, this cutting can be performed by means of a blade 29, mounted to slide in line with the junction area 26 and which slices the material while the preform 1 is driven in rotation. As a variant, the cutting can be performed with a laser or a jet of water.

The upper part 11 of the blank 10 that is thus cut can be discarded to be recycled. The container 6 is for its part intended to be filled, as illustrated in FIG. 9 (it can be a liquid, a paste, or even a solid product such as a powder), then closed, as illustrated in FIG. 10, by means of a lid 30 provided with a thread 31 that engages helically with the threading 25 formed on the sleeve 23 that forms the wide neck 9 of the container.

The screwing of the lid 30 is easy because the threading 25 is correctly formed in the sleeve 23. The same is true for the subsequent unscrewing, when the container 6 is used.

1. Method for manufacturing a container (6) made of plastic material having a threaded wide neck (9), the method comprising:
heating a preform (1) having a body (2) formed from a polyester, onto which a sleeve (23) formed from a polyolefin is slipped, this sleeve (23) being positioned in line with an area (24) of the body (2) of the preform (1) corresponding to the wide neck (9) of the container (6);
inserting the preform (1) thus heated, with the sleeve (23), into a mold (8) provided with a wall (15) defining an impression of the container (6) and including a threaded area (21) having the impression of the wide neck (9);
injecting into the preform (1) a pressurized fluid to form a blank (10) of the container (6) by taking an impression against the wall (15) of the mold (8), this blank (10) comprising a lower part that includes the wide neck (9) with a threading (25) formed in the sleeve (23) and an upper part (11) topping the wide neck (9);
separating the upper part (11) of the blank (10) from its lower part that thus forms the container (6).

2. Method according to claim 1, in which the separation operation is performed by cutting.

3. Method according to claim 2, in which the cutting is performed along a line (28) that is adjacent to the sleeve (23).

4. Method according to claim 1, in which the body (2) of the preform (1) is made of PET.

5. Method according to claim 1, in which the sleeve (23) is made of HDPE.

6. Method according to claim 1, wherein the sleeve (23) has, in cross-section, a thickness (E) of between 0.5 mm and 2.5 mm.

7. Method according to claim 6, wherein the sleeve (23) has, in cross-section, a thickness (E) that is less than or equal to 1.5 mm.

8. Method according to claim 1, in which the fluid is injected into the preform (1) at a pressure that is less than 15 bars.

9. Method according to claim 8, in which the fluid is air.

10. Container (6) made of plastic material comprising a side wall (13) formed from a polyester, and a wide neck (9) provided with a threading (25), this container (6) being wherein the threading (25) of the neck is done in a sleeve (23) formed from a polyolefin that covers an upper end portion (27) of the side wall (13), with the upper end portion (27) of the side wall (13) having an attenuated impression of the threading (25).

11. Container according to claim 10, wherein the side wall (13) is made of PET.

12. Container according to claim 10, wherein the sleeve (23) is made of HDPE.

13. Method according to claim 2, in which the body (2) of the preform (1) is made of PET.

14. Method according to claim 3, in which the body (2) of the preform (1) is made of PET.

15. Method according to claim 2, in which the sleeve (23) is made of HDPE.

16. Method according to claim 3, in which the sleeve (23) is made of HDPE.

17. Method according to claim 4, in which the sleeve (23) is made of HDPE.

18. Method according to claim 2, wherein the sleeve (23) has, in cross-section, a thickness (E) of between 0.5 mm and 2.5 mm.

19. Method according to claim 3, wherein the sleeve (23) has, in cross-section, a thickness (E) of between 0.5 mm and 2.5 mm.

20. Method according to claim 4, wherein the sleeve (23) has, in cross-section, a thickness (E) of between 0.5 mm and 2.5 mm.
